(19) United States
(12) Patent Application Publication
(10) Pub. No.: US 2009/0000884 A1
(43) Pub. Date: Jan. 1, 2009

(54) BRAKE ROTOR

(75) Inventors: Charles T. Layton, Beverly Hills, MI (US); Nathanial D. Hincher, Wixom, MI (US); Philip N. Jedele, Ypsilanti, MI (US)

Correspondence Address: DOBRUSIN & THENNISCH PC, 29 W LAWRENCE ST, SUITE 210, PONTIAC, MI, 48342, US

(73) Assignee: Akebono Corporation (North America)

(21) Appl. No.: 11/768,599

(22) Filed: Jun. 26, 2007

(51) Int. Cl. F16D 65/12

(52) U.S. Cl. 188/218 XL

(57) ABSTRACT

The present invention is predicated upon improved brake rotors and methods of forming thereof which include tangential stiffening to reduce vibration and noise of the brake rotor.

### FIELD OF THE INVENTION

The present invention is predicated upon systems and methods for improving brake rotors and more specifically reduction of vibration and noise generated thereby during operation.

### BACKGROUND OF THE INVENTION

Brake vibration and resulting noise therefrom has long been a common problem for brake suppliers and vehicle manufacturers. This vibration and noise is a source of customer dissatisfaction resulting in warranty costs and loss of future sales.

With respect to brake rotor systems, sliding contact between the pads and rotor during brake operation may excite the rotor to vibrate in various modes. These modes may be tangential (e.g. in-plane) or normal (e.g. out-of-plane) with respect to the friction surfaces of the rotor disc. These modes are mainly influenced by the rotor geometry, and to a lesser extent the surrounding components and suspension of the vehicle system.

For packaging and thermal performance, the geometry of the rotors, particularly the friction plates, is generally fixed. This invention describes means of designing the rotor to influence its response to excitation within the design limits imposed by packaging and thermal performance.

Examples of efforts in the art toward rotor design are found in U.S. Pat. Nos. 6,193,023; 6,454,958; and 6,655,508; all incorporated by reference herein.

### SUMMARY OF THE INVENTION

The present invention seeks to improve on prior brake systems and particularly vibration and noise thereof by providing an improved rotor design having tangential stiffening features located about the rotor axis. In one aspect, the present invention provides a cast brake rotor. The rotor includes a pair of spaced apart plates defining an outer circumference and a rotational axis. The rotor also includes a fin pattern that is located between the spaced apart plates, wherein the fin pattern includes a plurality of cast fins located between the plates and at least one tangentially oriented arcuate cast fin spaced apart from the plurality of cast fins and having an outer wall that extends at least 30° about the rotor (e.g. greater than about 90°). In another aspect, the present invention provides a cast brake rotor. The rotor includes a pair of spaced apart plates defining an outer circumference and a rotational axis. The rotor also includes a fin pattern that is asymmetrical about the rotational axis and is located between the spaced apart plates. The fin pattern includes a plurality of radially aligned cast fins located between the plates, and optionally an odd number of tangentially oriented arcuate cast fins having an outer wall that extends at least 30 about the rotor (e.g. greater than about 90°).

It should be appreciated that the above referenced aspects and examples are non-limiting as others exist within the present invention, as shown and described herein.

### BRIEF DESCRIPTION OF THE DRAWINGS

FIG. 1 illustrates a brake rotor according to the teaching of the present invention.

FIG. 2 illustrates a cross section of the rotor shown in FIG. 1.

FIGS. 3 through 8 illustrate patterns of stiffening members according to the teachings of the present invention.

FIGS. 9 through 13 illustrate brake rotor stiffening patterns according to the teachings of the present invention.

### DETAILED DESCRIPTION

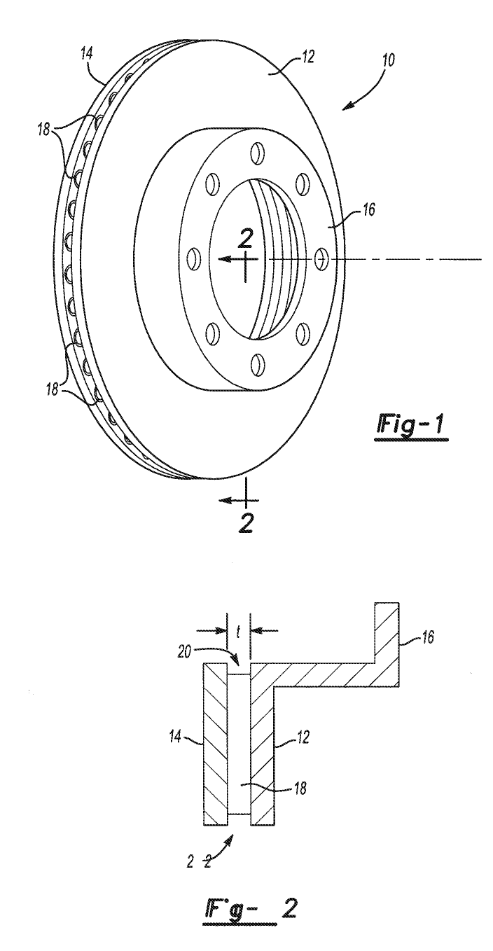

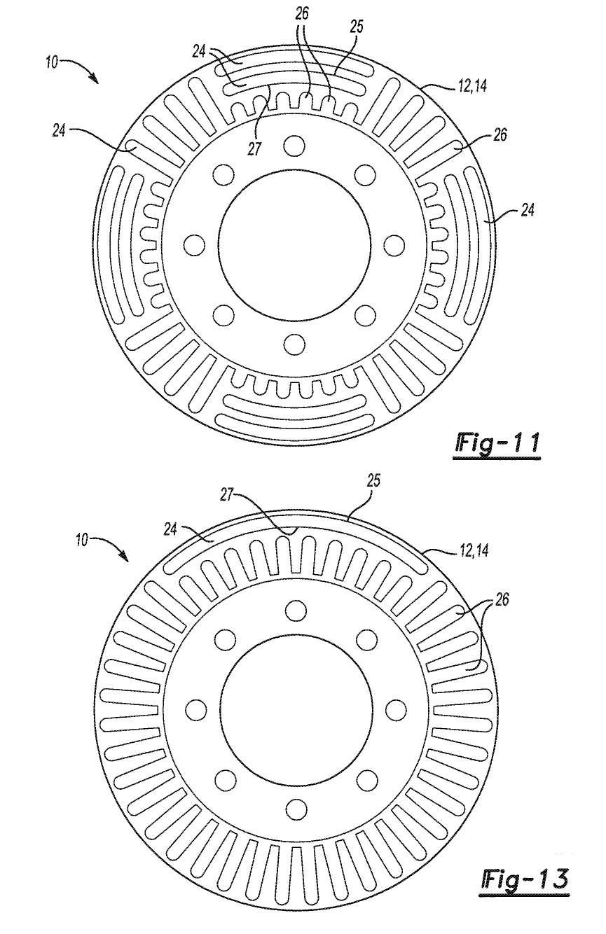

The present invention is directed to a cast brake rotor that includes a pair of spaced apart plates defining an outer circumference and a rotational axis. A fin pattern is located between the spaced apart plates including a plurality of cast fins located between the plates, and at least one tangentially oriented arcuate cast fin spaced apart from the plurality of cast fins and having an outer wall that extends at least 30° (e.g., at least about 90°, at least about 135°, at least about 180°, or even at least about 270°) about the rotor. The at least one tangentially oriented arcurate cast fin generally will have an outer wall that is spaced inwardly from the outer circumference of the rotor toward the rotational axis. Though other configurations are possible, the plurality of cast fins may include at least one radially oriented fin and at least one tangentially orientated arcurate cast fin that extends to a location that is substantially juxtaposed with a distal end of at least one radially orientated fin. It is possible that a plurality of arcuate cast fins will be employed. They may be spaced apart from each other in end to end relationship. They may be spaced apart radially relative to each other with respect to the rotational axis. For example, for the latter, their respective ends may be offset relative to each other. One approach is to employ a pattern that is generally asymmetrical about the rotational axis of the rotor. Such approach or others may employ a pattern that employs an odd number of tangentially oriented arcuate cast fins. Various examples are provided in accordance with the drawings of FIGS. 1 through 13.

Referring to FIGS. 1 and 2, by way of general background, one example of a rotor 10 of a disc brake is illustrated. The rotor includes a first friction plate 12 and a second friction plate 14. The first, second or both friction plates are further attached to a flange 16 for mounting to an axle portion of a vehicle. The first and second friction plate may be joined together through a plurality of fin members 18. In this configuration, air can travel between the friction plates, e.g. via a substantially continuous and relatively uninterrupted flow path and stiffening members to provide cooling thereof. Accordingly, it is contemplated that the air can move from an interior portion 20 of the first or second friction plate to an exterior portion 22. The present invention is directed to the geometry, orientation and placement of the fin members 18. In a particular aspect, according to the present invention, the members are provided in a fin pattern that includes a structure for tangentially stiffening the rotor as compared with a rotor structure that does not include such fin pattern.

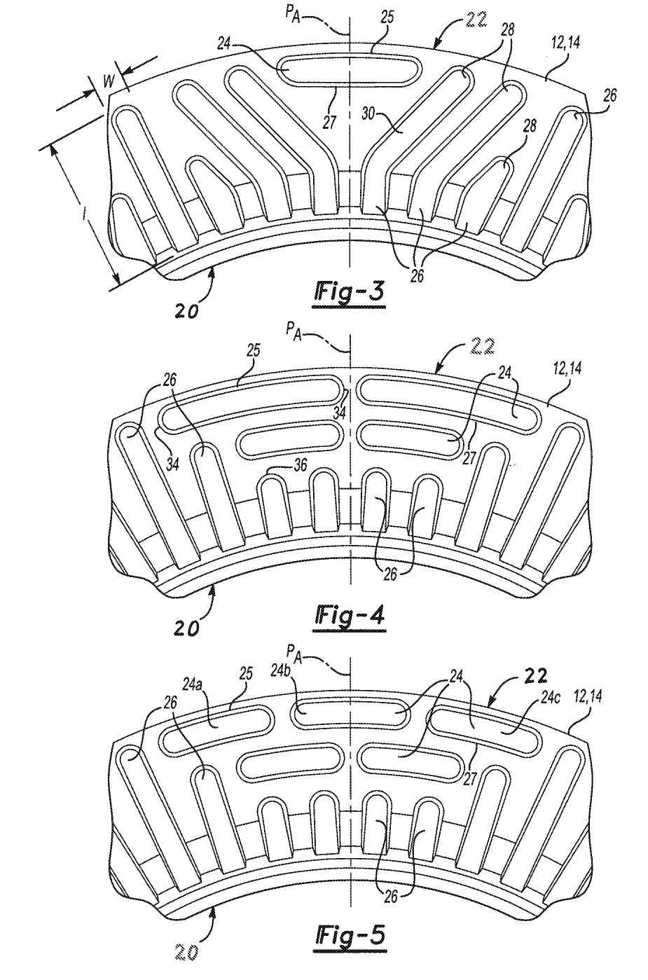

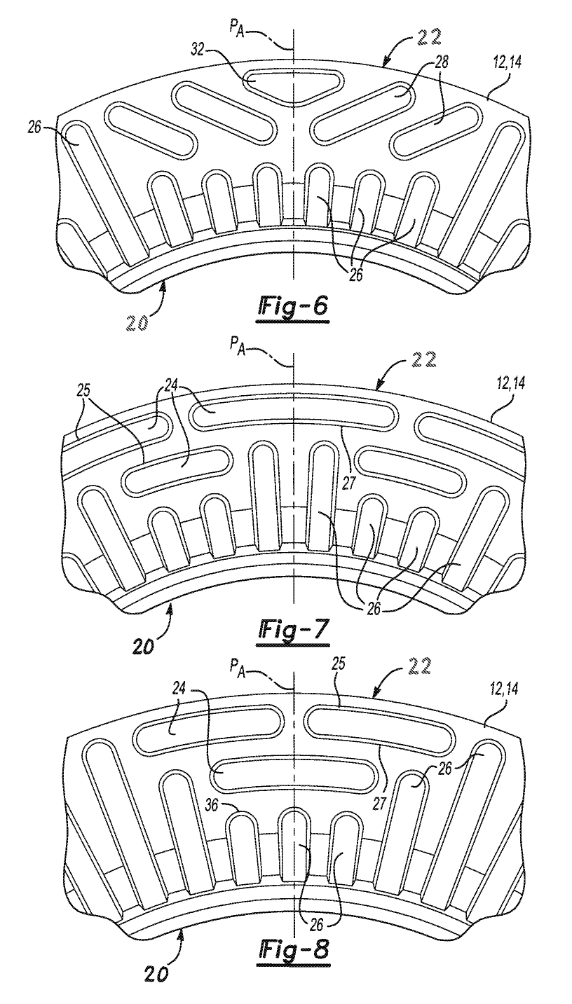

By way of illustration, referring to FIGS. 3 through 8, exemplary configurations of stiffening fin members oriented tangentially or having tangential portions 24 are shown. In each example shown, the tangential fin member includes at least one generally tangential arcuate surface, particularly one that has a radius originating from the rotor axis. The tangential stiffening member includes an outer wall 25 and an inner wall 27. Optionally, the fin pattern may have at least a portion oriented generally at an angle with respect to a radial or tangential component, e.g. a diagonal fin portion or member 28, for limiting both radial and tangential movement (e.g. vibration or otherwise) of the rotor. The rotor or stiffening pattern may include at least one bidirectional fin portion or member 30 that extends a combination of directions (e.g. tangential, radial, diagonal or otherwise). In still another configuration, the members may comprise members that include a combination of a radial and a tangential component, such as the multi-directional fin 32 of FIG. 6.

The following describes different patterns that may be used with the rotor and methods of the present invention. However, it should be appreciated that these patterns should be considered non-limiting. For example, it is contemplated that any of the members shown in the patterns may be replaced with other stiffening members, such as those shown and/or described herein to form other patterns. Also, it should be appreciated that a rotor is not restricted to a single pattern, but instead, may include different configurations of patterns about the rotor axis. Elements of patterns disclosed in one illustration may be combined with elements of patterns from another.

In a first example, referring to FIG. 3, a reinforcement pattern comprises a symmetric pattern of stiffening members. The pattern includes a combination of radially oriented fin members 26, tangentially oriented fin members 24, diagonally oriented fin members 28 and bidirectional fin members 30. The pattern illustrated in FIG. 3, is symmetrical with respect to a pattern axis PA, and includes a mirror image of stiffening fin members located on both sides of the pattern axis. The pattern includes a centrally located tangential fin member 24. Located adjacent the central fin member are one or more, or plurality, of additional bi-direction fin members 30, which include radial fin portion or member 26 and diagonal fin portion or member 28. The diagonal fin portions are in an overlapping relationship with each other and a portion of the centrally located fin member, with respect to the radius of the rotor axis.

In another example, referring to FIG. 4, a reinforcement pattern comprises another symmetric pattern of fin members configured to provide both tangential and radial stiffening of a brake rotor. The pattern includes a combination of radially oriented fin members 26 and tangentially oriented fin members 24. The pattern illustrated in FIG. 4, is symmetrical with respect to a pattern axis P_{A}, and includes a mirror image of fin members located on both sides of the pattern axis. Referring to one half, the pattern includes a plurality of, and more specifically four, radially oriented members 26 that are generally evenly spaced, with respect to one another, from a central portion of the pattern to an end portion. The radially oriented fin members extend generally from an interior portion of the frictions plates to an exterior portion of the friction plates or another fin member. In the specific pattern shown, the radially oriented members are variable in length. The half of the pattern also includes a plurality of, or more specifically two, partially overlapping tangentially oriented fin members 24. The tangentially oriented fin members extend from a central portion of the pattern towards an end portion and more specifically the radially oriented fin members.

As shown, the tangential oriented fin members 24 and radially oriented fin members include distal end portion 34 and 36, respectively. It is contemplated that the distal end portions of the tangential or radial fin member may extend to another tangential or radial fin member. However, in one preferred configuration, it is contemplated that the distal end portions are spaced relative to another fin member to allow for airflow therethrough.

In another example, referring to FIG. 5, a pattern comprises another symmetric pattern of stiffening fin members that includes a combination of radially oriented fin members 26 and tangentially oriented fin members 24. The pattern illustrated in FIG. 5, is symmetrical with respect to a pattern axis P_{A}, and includes a mirror image of stiffening fin members located on both sides of the pattern axis. Referring to one half, the pattern includes a plurality of, and more specifically four, radially oriented fin members 26 that are generally evenly spaced, with respect to one another, from a central portion of the pattern to an end portion. The radially oriented fin members extend generally from an interior portion of the frictions plates to an exterior portion of the friction plates or another reinforcement member. In the specific pattern shown, the radially oriented fin members are variable in length. The pattern includes a centrally located tangentially oriented fin member 24 and one or more, or a plurality of tangentially oriented fin members. The tangentially oriented fin members extend from the central portion of the pattern to an end portion of the pattern or a radially oriented fin member, as seen with members 24a, 24b and 24c. The tangentially oriented fin members are in an overlapping relationship and are located at different radiuses with respect to the rotor axis. That is, the ends of the stiffeners are radially offset relative to each other.

In another example, referring to FIG. 6, a reinforcement pattern comprises a symmetric pattern of fin members configured to provide both tangential and radial stiffening of a brake rotor. The pattern includes a combination of radially oriented fin members 26, diagonally oriented fin members 28 and multi-directional fin members 32. The pattern illustrated in FIG. 6, is symmetrical with respect to a pattern axis P_{A}, and includes a mirror image of fin members located on both sides of the pattern axis. The pattern includes a centrally located multi-directional fin member 32 oriented in both a tangential direction and a radial direction. Located adjacent the central fin member are one or more, or plurality, of diagonal fin members 28. The diagonal members are in an overlapping relationship with each other and a portion of the centrally located fin member, with respect to the radius of the rotor axis. The pattern also includes a plurality of, and more specifically four, radially oriented fin members 26 that are generally evenly spaced, with respect to one another, from a central portion of the pattern to an end portion. The radially oriented fin members extend generally from an interior portion of the frictions plates to an exterior portion of the friction plates or another fin member. In the specific pattern shown, the radially oriented fin members are variable in length.

In another example, referring to FIG. 7, a reinforcement pattern comprises another symmetric pattern of fin members configured to provide both tangential and radial stiffening of a brake rotor. The pattern includes a combination of radially oriented fin members 26 and tangentially oriented fin members 24. The pattern illustrated in FIG. 7, is symmetrical with respect to a pattern axis P_{A}, and includes a mirror image of fin members located on both sides of the pattern axis. Referring to one half, the pattern includes a plurality of, and more specifically four, radially oriented fin members 26 that are generally evenly spaced, with respect to one another, from a central portion of the pattern to an end portion. The radially oriented fin members extend generally from an interior portion of the frictions plates to another fin member. In the specific pattern shown, the radially oriented fin members are variable in length. The pattern also includes a centrally located tangentially oriented fin member 24 and one or more, or a plurality of tangentially oriented fin members. The tangentially oriented fin members extend from the central portion of the pattern to an end portion of the pattern. Also, one tangentially oriented fin member may extend between two radially oriented fin members. The tangentially oriented fin members are in an overlapping relationship (such that their respective ends are offset radially relative to each other) and are located at different radiuses with respect to the rotor axis.

In another example, referring to FIG. 8, a reinforcement pattern comprises another symmetric pattern of fin members. The pattern includes a combination of radially oriented fin members 26 and tangentially oriented fin members 24. The pattern illustrated in FIG. 8 is symmetrical with respect to a pattern axis P_{A}, and includes a mirror image of fin members located on both sides of the pattern axis. Referring to one half, the pattern includes a plurality of, and more specifically four, radially oriented fin members 26 that are generally evenly spaced, with respect to one another, from a central portion of the pattern to an end portion. The radially oriented fin members extend generally from an interior portion of the frictions plates to an exterior portion of the friction plates or another reinforcement member. In the specific pattern shown, the radially oriented fin members are variable in length. The half of the pattern also includes a plurality of, or more specifically two, overlapping tangentially oriented fin members 24. The tangentially oriented fin members extend from a central portion of the pattern towards an end portion and more specifically the radially oriented fin members. The tangentially oriented fin members are also variable in length.

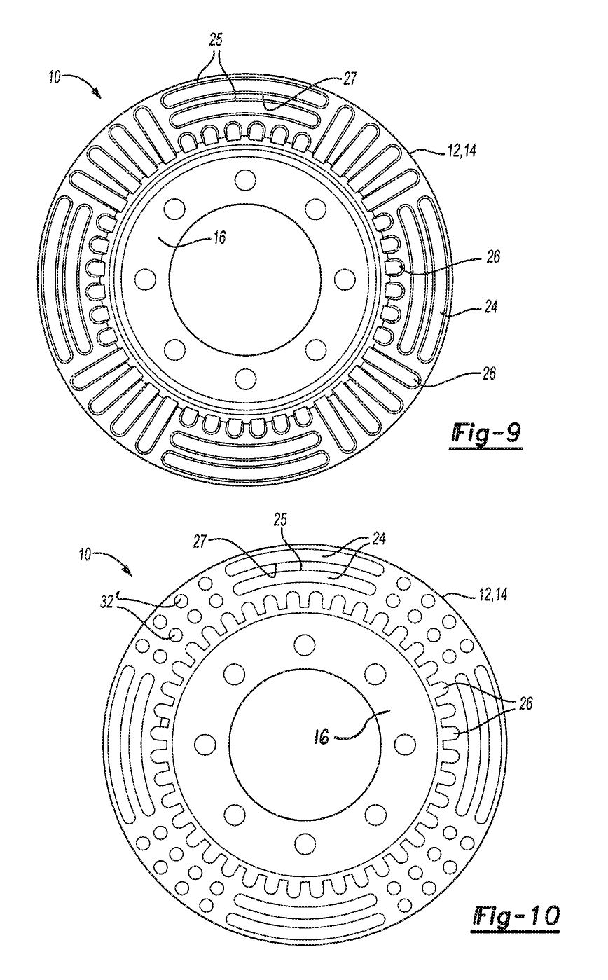

In yet other examples, referring to FIGS. 9-13, there are also shown a number of exemplary configurations. In these exemplary configuration, the rotors include at least one, or plurality, of tangentially oriented arcuate fin members. It is contemplated that the number of tangential fin members may comprise an odd number of members. Also, it is contemplated that with more than one tangential fin member, two or more of the tangential fin members may include end portions that are spaced apart in an end to end relationship, are spaced apart radially inward relative to each other, with respect to the rotor axis, or both.

In one preferred configuration, the tangentially oriented fin members include an inner wall 25 and outer wall 27, wherein the outer wall is spaced inwardly from the outer circumference of the rotor (e.g. exterior portion 22 of the friction plates or otherwise). For example, the tangential fin members may be spaced inwardly from the outer circumference at a distance of from about 0.5 mm to about 5 mm or more. This may include the outer most tangentially oriented fin member or an inwardly positioned tangentially oriented fin member, with respect to the rotor axis.

Similarly, it is also contemplated that any other member, such as one or more radially oriented fin member, may also be spaced inwardly from the outer circumference of the rotor, by the same distance as the tangential fin members, or otherwise. It is contemplated that a distal end portion 34 of the tangentially oriented fin member 24 or a distal end 36 of the radially oriented member 26 may be spaced apart or substantially juxtaposed with respect to another of said tangentially oriented fin member, radially oriented fin member or otherwise.

As shown in FIGS. 9 through 12, the rotor includes a symmetrical repeated pattern about the rotational axis of the rotor having a plurality of tangentially oriented fin members 24, which are spaced from the outer portion of the rotor circumference and which are cast and extend between the first and second friction plates 12, 14. The plurality of tangential fin member are formed in a plurality of groups, wherein each group includes a first tangential fin member inwardly spaced from the rotor circumference and a second tangential fin member inwardly spaced therefrom. The rotor also includes a plurality of equally spaced radially oriented cast fin members. The radially oriented members include a distal end that extends to, but is spaced from, a tangentially oriented member, the outer circumference portion of the rotor, or both.

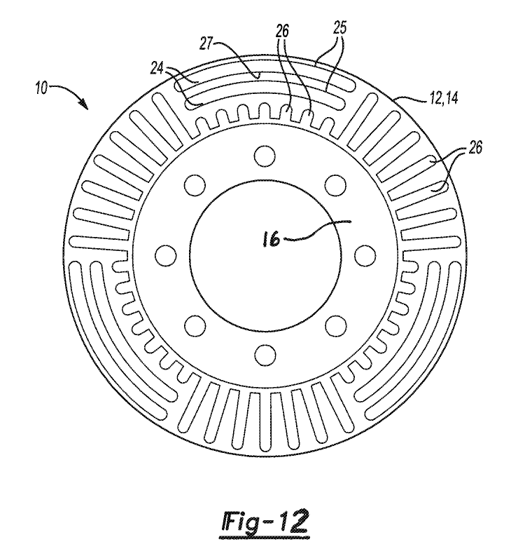

As shown in FIG. 13, a rotor may include an asymmetrical rotor pattern about the rotor axis, which is not repeated, such as one including at least one tangentially oriented fin member 24, which is spaced from the outer portion of the rotor circumference and which is cast and extends between the first and second friction plates 12, 14. While a single tangential fin member is shown oriented approximately 90° about the rotor axis, it should be appreciated that other tangential fin members may be added (e.g., to total an odd number of members) or otherwise to form an asymmetrical, a non-repeated pattern, or both. The tangential fin member is shown to include an outer wall that is inwardly spaced from the rotor circumference. The configurations herein may have such outer wall co-extensive with the rotor circumference. The rotor also includes a plurality of equally spaced radially oriented cast fin member. The radially oriented fin members include a distal end that extends to, but is spaced from, the tangentially oriented fin member, the outer circumference portion of the rotor, or both.

Also, it should be appreciated that the above examples shown in 9 through 13 may be modified to form yet additional examples using the features and configurations described herein. For example, the example shown in FIGS. 9 through 12 may be altered to form an asymmetrical or non-repeated fin pattern and the example shown in FIG. 13 may be altered to form a symmetrical fin pattern. For any of the examples disclosed herein, radially oriented fins may be employed of differing lengths. One or a plurality of posts (e.g., posts 32+ of FIG. 10) or other shaped fin may be employed in place of a continuous fin, or vice versa. Further, one portion (e.g., one-half of one pattern) of one example may be combined with one or more portions of another example. Tangential fins may have a constant radius of curvature, or one or more curvature radii that vary relative to the rotational axis. Multi-directional fins (e.g., including a radially oriented portion and a tangentially oriented portion may be employed (such as in FIG. 6)).

Without intending to be bound by theory, it is believed that certain of the noise that is overcome by the present invention is due to a vibration that results from a plurality of frequencies (e.g., at least a first frequency and a second frequency) arising from one or more deformation modes of the rotor. The invention thus contemplates a method for designing an automotive vehicle brake for reducing noise contributed by a cast brake rotor of an automotive vehicle, comprising the steps of identifying at least a first and a second frequency in at least one deformation mode for a cast rotor having a rotational axis and including a pair of spaced apart plates defining an outer circumference and a fin pattern (e.g., a pattern including a plurality of radially oriented fins located between the plates); and selectively introducing a local change of rotor casting fin pattern geometry by including at least one tangentially oriented arcuate cast fin (e.g., any of the pattern geometries disclosed herein, such as one including a cast fin having an outer wall that is spaced inwardly from the outer circumference of the rotor toward the rotational axis), for increasing the difference between the first and the second frequency (e.g., by at least about 100 Hz, more specifically at least about 300 Hz, or even still more specifically at least 500 Hz or higher).

The first frequency may be from an in-plane mode and the second frequency is from a mode that is different from the in-plane mode (e.g., an out-of-plane mode). The first frequency and the second frequency may be a repeated frequency from within a mode. In one specific embodiment, the at least one deformation mode is a second order deformation mode, and specifically it is a second order deformation mode. The arcuate cast fin may be substantially free of any radially oriented fin component. Though it is possible that the resulting fin pattern may be symmetrical about the rotational axis, as seen in the illustration of FIG. 13, it may also be asymmetrical. Any of the arcuate cast fins may be connected with another fin (e.g., directly to only one, to only two, or to more than two radially oriented fins). However, generally it is expected that any arcuate cast fin will be separated from the radially oriented fins.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1) A cast brake rotor, comprising:
a) a pair of spaced apart plates defining an outer circumference and a rotational axis;
b) a fin pattern that is located between the spaced apart plates including:
i) a plurality of cast fins located between the plates; and
ii) at least one tangentially oriented arcuate cast fin spaced apart from the plurality of cast fins and having an outer wall that extends at least 30 about the rotor.

2) The rotor of claim 1, wherein the at least one tangentially oriented arcurate cast fin has an outer wall that is spaced inwardly from the outer circumference of the rotor toward the rotational axis.

3) The rotor of claim 1, wherein a plurality of the cast fins are radially oriented and have a radially oriented length with respect to the rotational axis.

4) The rotor of claim 3, wherein the plurality of cast fins include at least two cast fins having different radial oriented lengths.

5) The rotor of claim 3, wherein at least one cast fine of the plurality of cast fins includes a distal end that is spaced inwardly from the outer circumference of the rotor toward the rotation axis.

6) The rotor of claim 3, wherein the plurality of cast fins includes at least one radially oriented fin and the at least one tangentially orientated arcurate cast fin extends to a location that is substantially juxtaposed with a distal end of at least one radially orientated fin.

7) The rotor of claim 1, wherein the at least one tangentially oriented arcuate cast fin has an outer wall that extends at least at least 90° about the rotor.

8) The rotor of claim 1, wherein the at least one tangentially oriented arcuate cast fin has an outer wall that extends at least at least 135° about the rotor.

9) The rotor of claim 1, wherein the at least one tangentially oriented arcuate cast fin has an outer wall that extends at least at least 180° about the rotor.

10) The rotor of claim 1, wherein the fin pattern includes a plurality of tangentially orientated arcuate cast fins.

11) The rotor of claim 10, wherein a first group of the tangentially oriented arcuate cast fins are spaced apart from each other in end to end relationship.

12) The rotor of claim 10, wherein a first group of the tangentially oriented arcuate cast fins are spaced apart radially inward relative to each other with respect to the rotational axis.

13) The rotor of claim 10, wherein the plurality of tangentially orientated arcuate cast fins extend at least 180° about the rotor.

14) The rotor of claim 10, wherein the plurality of tangentially orientated arcuate cast fins extend at least 270° about the rotor.

15) The rotor of claim 10, wherein the plurality of tangentially orientated arcuate cast fins extend about 360° about the rotor.

16) The rotor of claim 1, wherein the fin pattern is substantially asymmetrical about the rotational axis

17) A cast brake rotor, comprising:
a) a pair of spaced apart plates defining an outer circumference and a rotational axis;
b) a fin pattern that is asymmetrical about the rotational axis and is located between the spaced apart plates, consisting essentially of:
i) a plurality of radially aligned cast fins located between the plates; and
ii) an odd number of tangentially oriented arcuate cast fins having an outer wall that extends at least 30° about the rotor.

18) The rotor of claim 17, wherein the tangentially oriented arcurate cast fin has an outer wall that is spaced inwardly from the outer circumference of the rotor toward the rotational axis.

19) The rotor of claim 17, wherein the at least one of the tangentially orientated arcurate cast fin extends to a location that is substantially juxtaposed with a distal end of at least one radially orientated fin.

20) The rotor of claim 17, wherein the tangentially oriented arcuate cast fin has an outer wall that extends at least at least 90° about the rotor.

21) The rotor of claim 17, wherein the tangentially oriented arcuate cast fin has an outer wall that extends at least at least 135° about the rotor.

21) The rotor of claim 1, wherein the fin pattern includes a plurality of tangentially orientated arcuate cast fins.

22) The rotor of claim 21, wherein a first group of the tangentially oriented arcuate cast fins are spaced apart from each other in end to end relationship.

23) The rotor of claim 21, wherein a first group of the tangentially oriented arcuate cast fins are spaced apart radially inward relative to each other with respect to the rotational axis.

24) The rotor of claim 21, wherein the plurality of tangentially orientated arcuate cast fins extend at least 180° about the rotor.

25) The rotor of claim 21, wherein the plurality of tangentially orientated arcuate cast fins extend at least 270° about the rotor.
